(19) United States
(12) Patent Application Publication
(10) Pub. No.: US 2009/0003751 A1
(43) Pub. Date: Jan. 1, 2009

(54) CAGE

(75) Inventor: Knut AUFFAHRT, Wilhelmsdorf (DE)

Correspondence Address: LUCAS & MERCANTI, LLP, 475 PARK AVENUE SOUTH, 15TH FLOOR, NEW YORK, NY, 10016, US

(73) Assignee: SCHAEFFLER KG, Herzogenaurach (DE)

(21) Appl. No.: 12/163,019

(22) Filed: Jun. 27, 2008

(30) Foreign Application Priority Data
Jun. 29, 2007 (DE) 10 2007 030 217.9

(51) Int. Cl. F16C 33/46

(52) U.S. Cl. 384/575

(57) ABSTRACT

The invention relates to a cage (1) for rolling bodies (6), in particular a needle cage, consisting of two side rings (2, 3) spaced apart from one another in the axial direction and having end faces, the side rings (2, 3) being connected, to form pockets (5) receiving rolling bodies (6), to transverse webs (4) spaced apart from one another uniformly in the circumferential direction.

The cage (1) is distinguished in that the end faces at least partially follow a course which deviates at an angle of inclination (α) of 90° with respect to a bearing axis (9).

This ensures a particularly effective lubrication between the end faces of the cage (1) and the connecting structure, this lubrication being important particularly in the case of bearings subjected to high loads.

### FIELD OF THE INVENTION

The invention relates to a cage for rolling bodies, in particular a needle cage, consisting of two side rings spaced apart from one another in the axial direction and having end faces, the side rings being connected, to form pockets receiving rolling bodies, to transverse webs spaced apart from one another uniformly in the circumferential direction. The invention relates, moreover, to a bearing arrangement for the rotatable mounting of a planet wheel.

### BACKGROUND OF THE INVENTION

As a person skilled in the art knows, the mounting conditions for crank pins in two-stroke and four-stroke internal combustion engines and in epicyclic transmissions for motor vehicles must satisfy the most stringent requirements. The loads, speeds, acceleration, lubrication, shaft alignment or misalignment and temperatures make the choice of the correct bearing critical. In this regard, it is also known that arrangements with needle rollers and a cage are generally accepted as the first choice for satisfying this requirement.

It is known, further, that the lubricating conditions of the bearing cages are of essential importance. Thus, for example, U.S. Pat. No. 4,192,560 discloses a needle-bearing cage, the surface area of which is provided on both sides, in the region of the side rings, with recesses which first run in the axial direction and then swing round radially. These recesses serve as lubricating pockets and ensure that friction between the surface area of the cage and the connecting structure is reduced.

DE 197 38 331 A1 discloses a further bearing cage for cylindrical rolling bodies, which has on its outer surface area lubricant ducts which run both in the circumferential direction and in the axial direction and which again lower the friction between the connecting structure and bearing cage. However, specific applications are also known in which the cage has to assume axial guidance. In this case, the end faces of the side rings slide on the sides of the run-on faces serving for lateral delimitation and generate friction there. Attempts have been made to reduce this friction by providing the end faces of the side rings with recesses which are spaced apart from one another uniformly in the circumferential direction. A cage of this type may be gathered, for example, from U.S. Pat. No. 5,326,277. The disadvantage of this is that such a cage is relatively complicated to manufacture due to the recesses and, furthermore, still has friction in the axial direction, since these recesses extend only over part of its circumferential extent.

### SUMMARY OF THE INVENTION

Starting from the disadvantages of the known prior art, therefore, the object on which the invention is based is to develop further a generic cage for rolling bodies in such a way that the axial friction caused by the bearing of the side rings of the cage against the connecting structure is reduced.

According to the invention, this object is achieved according to the characterizing clause of claim 1 in conjunction with its precharacterizing clauses in that the end faces at least partially follow a course which deviates at an angle of inclination of 90° with respect to a bearing axis.

This course makes it possible to form, between the end face of the cage and the connecting structure, a load-bearing lubricating film which leads to an appreciable reduction in friction between the cage and connecting structure. The temperature of the overall system is thereby reduced considerably. The result of this, in turn, is that the oil can build up a better lubricating action which, in turn, leads to an increase in the overall bearing service life.

Further advantageous embodiments of the invention are described in the subclaims.

Thus, according to claim 2, there is provision for the angle of inclination to assume an amount ≦10°. By virtue of this technical measure, a triangular lubricating gap is formed between the end face of the cage and the connecting structure, so that the oil is pressed into this triangular lubricating wedge by the centrifugal force.

In a further feature of the invention according to claim 3, there is provision for the transverse webs to consist of portions which run parallel to one another and lie partly inside and partly outside a reference circle and which are connected to one another by means of portions running obliquely with respect to the bearing axis. This bent cage, known per se, is distinguished by a particularly high stability and by a good guidance of the needle rollers.

In this case, this bent cage may be of M-shaped design according to claim 4 or of W-shaped design according to claim 5, and, according to claim 6, it may be externally guided, internally guided or guided by rolling bodies. The configuration of the cage is of somewhat minor importance within the scope of the invention, and it is important merely that the axial friction of the cage between the end face of the side rings and the connecting structure is decisively reduced.

As already stated in the introductory part of the description of the invention, the mounting, particularly in epicyclic transmissions for motor vehicles, must meet the most stringent requirements. According to the invention, therefore, there is provision for a bearing arrangement for the rotatable mounting of a planet wheel on a planet-wheel bolt which is received by a planet-wheel carrier, the planet wheel being held on the planet-wheel bolt via a radial rolling bearing, the rolling bodies of which are received in a cage which is configured according to at least one of claims 1 to 6.

Further features of the invention may be gathered from the following description and from the drawings in which an exemplary embodiment of the invention is illustrated in simplified form.

### BRIEF DESCRIPTION OF THE DRAWINGS

In the drawings:

FIG. 1 shows a detail of a perspective illustration of a bearing cage according to the invention,

FIG. 2 shows a partial axial section through the bearing cage according to the invention, as shown in FIG. 1, and

FIG. 3 shows a longitudinal section through a F planet-wheel mounting with a cage according to the invention.

### DETAILED DESCRIPTION OF THE DRAWINGS

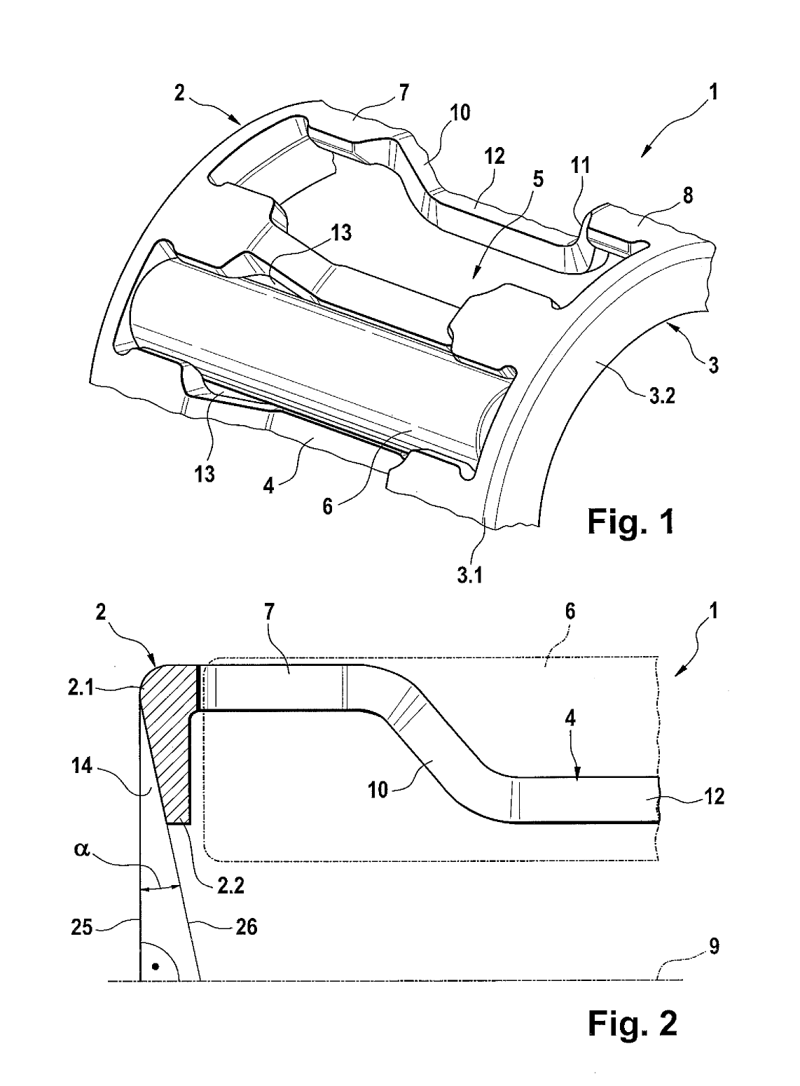

The cage 1 illustrated in FIGS. 1 and 2 consists of the two side rings 2, 3 which are connected to one another by means of a number of profiled webs 4 arranged so as to be distributed uniformly around the circumference. The pockets 5 thus obtained for the reception of rolling bodies 6 are delimited, on the one hand, by the side rings 2, 3 and, on the other hand, by the webs 4. The webs 4 are bent in the direction of the bearing center point over the rolling-body reference circle and consist of two portions 7, 8 which are joined at the side rings 2, 3 and which run parallel to the bearing axis 9. The portions 7, 8 lie outside the F reference circle and in each case merge into a portion 10, 11 directed obliquely with respect to the bearing axis 9, which portions, in turn, unite to form a portion 12 running parallel to the bearing axis 9 and lying inside the reference circle. The inner edges of the web portions 12 limit the radial play of the rolling bodies 6 inwards, while the radial play is limited outwards by the outer web portions 7, 8. It may be gathered, further, from FIG. 1 that in each case a free space 13 is present on both sides of the rolling body 6 in the region of the obliquely running portions 10, 11, that is to say in the profiling region of the webs 4. This freed region is necessary in order to F prevent a jamming of the rolling bodies 6 in the pockets 5.

As is evident, further, from FIGS. 1 and 2, the side rings 2, 3 are chamfered on their end faces, so as to form an upper contact face 2.1, 3.1 with which the cage 1 bears against the connecting structure, not illustrated. The set-back parts 2.2, 3.2 of the side rings 2, 3 therefore do not bear against the connecting structure. In the present exemplary embodiment, the two side rings 2, 3 run inwards, inclined at the angle of inclination α with respect to the bearing axis 9, so that a triangular lubricating gap 14 is formed on both sides. According to the invention, the angle of inclination α, on the one hand, is defined by the leg 25 which runs inwards from the upper contact face 2.1, 3.1 in the radial direction and which meets the bearing axis 9 at right angles. On the other hand, the associated other leg 26 follows the inwardly inclining end face of the two side rings 2, 3. This triangular lubricating gap 14 thus formed, which decreases outward in the radial direction, is particularly advantageous, because the lubricant is brought up to the contact face 2.1, 3.1 of the two side rings 2.3 by the centrifugal force prevailing in the bearing.

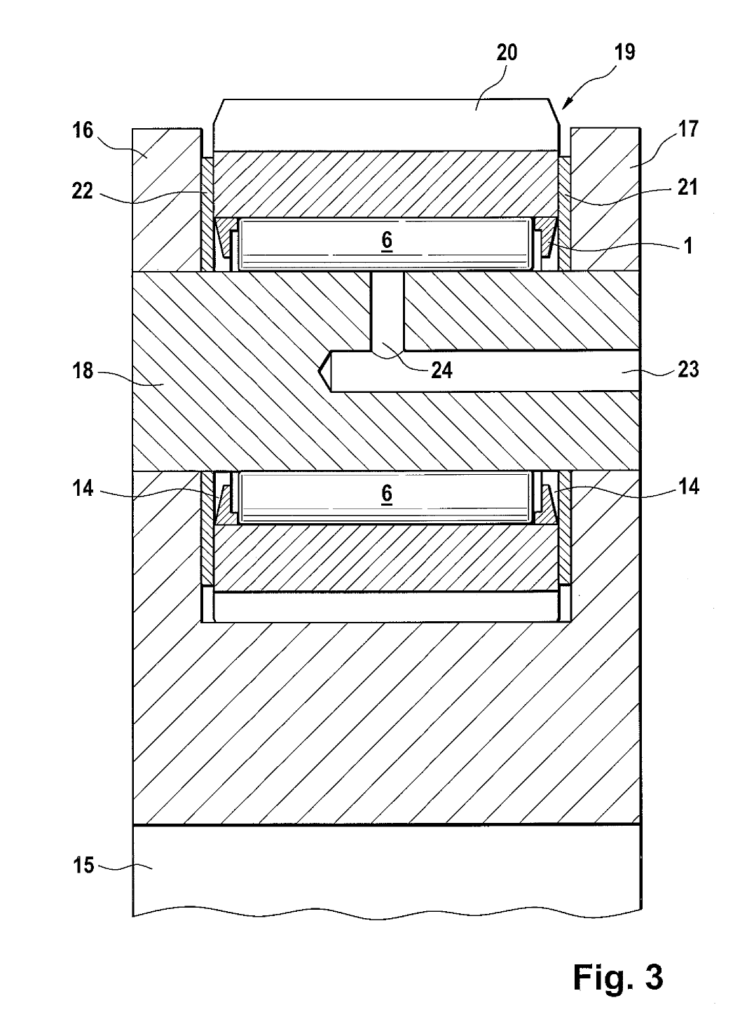

The planet-wheel carrier 15 shown partially in FIG. 3 has two side walls 16, 17, in which planet-wheel bolts 18 are secured in reception bores, not designated. Mounted rotatably on these planet-wheel bolts 18, via bearing needles 6 arranged in cages 1 designed according to the invention, are planet wheels 19, the teeth 20 of which mesh, on the one hand, with a ring wheel, not shown, and, on the other hand, with a sun wheel, likewise not shown. Run-on disks 21, 22 are arranged on the planet-wheel bolt 18 on both sides of the planet wheels 19 and usually consist of a material with good sliding properties, such as, for example, bronze-plated sheet metal, in order to avoid friction between the planet wheels 20 and the side walls 16, 17 of the planet-wheel carrier 15. The planet-wheel bolt 18 possesses an axial lubricant passage bore 23 and a radial lubricant passage bore 24 branching off from the latter. As can be seen, the cage 1 receiving the rolling bodies 6 is designed in the way according to the invention such that lubricating gaps 14 of triangular design are formed on both sides between the end faces of the cage 1 and the run-on disks 21, 22. The lubricant supplied to the bearing via the axial lubricant passage bore 23 and the lubricant passage bore 24 branching off from the latter in the radial direction is thus also distributed in the axial direction via the running faces during the rotation of the planet wheels 19, so that it penetrates into the triangular lubricating gap, is conveyed radially outward by the centrifugal force and thus reduces the friction between the side rings 2, 3 of the cage 1 and the run-on disks 21, 22.

### List of Reference Numerals

1 Cage
2 Side ring
Upper contact face
Set-back part
3 Side ring
5 Upper contact face
Set-back part
4 Web
5 Pocket
6 Rolling body
7 Portion
8 Portion
9 Bearing axis
10 Portion
11 Portion
12 Portion
13 Free space
14 Lubricating gap
15 Planet-wheel carrier
16 Side wall
17 Side wall
18 Planet-wheel bolt
19 Planet wheel
20 Tooth
21 Run-on disk
22 Run-on disk
23 Lubricant passage bore
24 Lubricant passage bore
25 Leg
26 Leg
27 α Angle of inclination

1. Cage for rolling bodies comprising two side rings spaced apart from one another in the axial direction and having end faces, the side rings being connected, to form pockets receiving rolling bodies, to transverse webs spaced apart from one another uniformly in the circumferential direction, wherein the end faces at least partially follow a course which deviates at an angle of inclination (α) of 90° with respect to a bearing axis.

2. Cage according to claim 1, wherein the angle of inclination (α) assumes an amount ≦10°.

3. Cage according to claim 1, wherein the transverse webs comprise portions which run parallel to one another and lie partly inside and partly outside a reference circle and which are connected to one another by means of portions running obliquely with respect to the bearing axis.

4. Cage according to claim 1, wherein it is of M-shaped design, and its portions adjoining the side rings and running parallel to the bearing axis are arranged outside the reference circle.

5. Cage according to claim 1, wherein it is of W-shaped design, and its portions adjoining the side rings and running parallel to the bearing axis are arranged inside the reference circle.

6. Cage according to claim 1, wherein it is externally guided, internally guided or guided by rolling bodies.

7. Bearing arrangement for the rotatable mounting of a planet wheel on a planet-wheel bolt which is received by a planet-wheel carrier, the planet wheel being held on the planet-wheel bolt via a radial rolling bearing, the rolling bodies of which are received in a cage, wherein the cage is designed according to claim 1.
